(19) United States
(12) Patent Application Publication
(10) Pub. No.: US 2022/0207301 A1
(43) Pub. Date: Jun. 30, 2022

(54) LEARNING APPARATUS, ESTIMATION APPARATUS, LEARNING METHOD, ESTIMATION METHOD, AND PROGRAM

(71) Applicant: NIPPON TELEGRAPH AND TELEPHONE CORPORATION, Tokyo (JP)

(72) Inventor: Tomoharu IWATA, Musashino-shi, Tokyo (JP)

(21) Appl. No.: 17/606,802

(22) PCT Filed: May 30, 2019
(86) PCT No.: PCT/JP2019/021489

§ 371 Date: Oct. 27, 2021

(51) Int. Cl. G06K 9/62; G06N 7/00

(52) U.S. Cl. CPC G06K 9/6257; G06N 7/005

(57) ABSTRACT

A learning apparatus includes: an input unit configured to input a first data set constituted by data indicative of being normal and a second data set constituted by a collection of data sets including at least one piece of data indicative of being anomalous; a calculation unit configured to calculate, using data included in the first data set and data included in the second data set, a value of an objective function utilizing a model and a derivative value of the objective function regarding a parameter of the model, the model estimating an anomaly score of data; and an updating unit configured to update, using the value of the objective function and the derivative value of the objective function, the parameter of the model.

### TECHNICAL FIELD

The present invention relates to a learning apparatus, an estimation apparatus, a learning method, an estimation method, and a program.

### BACKGROUND ART

There is known a task in which when data is provided, an anomaly is detected by estimating an anomaly score of the data. Such a task is also referred to as “anomaly detection” or the like, and is applied to, for example, detection of an anomaly that occurs in a device, detection of an anomaly that occurs in a communication network, detection of a credit-card fraud, and the like.

As a technique of implementing the anomaly detection, there have been known an unsupervised technique (see, for example, Non Patent Literature 1) and a supervised technique (see, for example, Non Patent Literature 2) in the related art.

### CITATION LIST

### Non Patent Literature

Non Patent Literature 1: Fei Tony Liu, Kai Ming Ting, and Zhi-Hua Zhou. “Isolation Forest”, 2008 Eighth IEEE International Conference on Data Mining IEEE, 2008. Non Patent Literature 2: Jiong Zhang, Mohammad Zulkernine, and Anwar Haque, “Random-Forests-Based Network Intrusion Detection Systems”, IEEE Transactions on Systems, Man, and Cybernetics, Part C (Applications and Reviews), 38(5), 649-659.

### SUMMARY OF THE INVENTION

### Technical Problem

However, when a label indicating whether or not each piece of data is anomalous is given, the unsupervised technique cannot effectively utilize the label.

On the other hand, the supervised technique can utilize the label indicating whether or not each piece of data is anomalous, but when the label is inaccurate (for example, the label and the data cannot be accurately associated with each other because a correct time at which an anomaly has occurred is not specified), performance of anomaly detection may be lowered.

An embodiment of the present invention has been made in view of the above-described circumstances, and an object thereof is to estimate an anomaly score of given data with high accuracy.

### Means for Solving the Problem

In order to achieve the above object, an embodiment of the present invention includes: an input unit configured to input a first data set constituted by data indicative of being normal and a second data set constituted by a collection of data sets including at least one piece of data indicative of being anomalous; a calculation unit configured to calculate, using data included in the first data set and data included in the second data set, a value of an objective function utilizing a model and a derivative value of the objective function regarding a parameter of the model, the model estimating an anomaly score of data; and an updating unit configured to update, using the value of the objective function and the derivative value, the parameter of the model.

### Effects of the Invention

It is possible to estimate an anomaly score of given data with high accuracy.

### BRIEF DESCRIPTION OF DRAWINGS

FIG. 1 is a diagram illustrating an example of an overall configuration of a learning apparatus and an estimation apparatus according to an embodiment of the present invention.

FIG. 2 is a flowchart illustrating an example of parameter training processing according to the embodiment of the present invention.

FIG. 3 is a flowchart illustrating an example of anomaly score estimation processing according to the embodiment of the present invention.

FIG. 4 is a diagram illustrating an example of a hardware configuration of the learning apparatus and the estimation apparatus according to the embodiment of the present invention.

### DESCRIPTION OF EMBODIMENTS

Hereinafter, an embodiment of the present invention will be described. In the embodiment of the present invention, a learning apparatus 10 and an estimation apparatus 20 will be described. The learning apparatus 10 trains a parameter of a model that can estimate an anomaly score of given data with high accuracy (hereinafter, also referred to as an “anomaly score estimation model”). The estimation apparatus 20 estimates an anomaly score of the given data by the model. Note that in the embodiment of the present invention, data indicative of being normal is represented by “normal data”, and data indicative of being anomalous is represented as “anomalous data”.

Anomaly Score Estimation Model

In the embodiment of the present invention, in a case where data is provided, a value that becomes low when the data frequently appears (i.e., when the probability of appearance is high) and becomes high when the data infrequently appears (i.e., when the probability of appearance is low) is used as an anomaly score. For example, it is possible to use a reconfigured error of an autoencoder as the anomaly score to define the following Equation (1) as an anomaly score estimation model.

[Math. 1]

α(x;θ)=∥x−g(f(x;θ_{f});θ_{g})∥² (1)

Here, f(·; θ_{f}) represents an encoder having a parameter θ_{f} and modeled by a neural network, and g(·; θ_{g}) represents a decoder having a parameter θ_{g} and modeled by a neural network. Furthermore, θ={θ_{f}, θ_{g}} represents a parameter of the anomaly score estimation model.

In the embodiment of the present invention, the above Equation (1) is used as the anomaly score estimation model and a case where the parameter θ of the anomaly score estimation model is trained by the learning apparatus 10 and a case where the trained parameter θ is used to estimate an anomaly score of data provided to the estimation apparatus 20 using the anomaly score estimation model will be described. Note that the anomaly score is not limited to the reconfigured error of the autoencoder and for example, an anomaly score used in unsupervised anomaly detection such as logarithmic likelihood may be used.

Overall Configuration

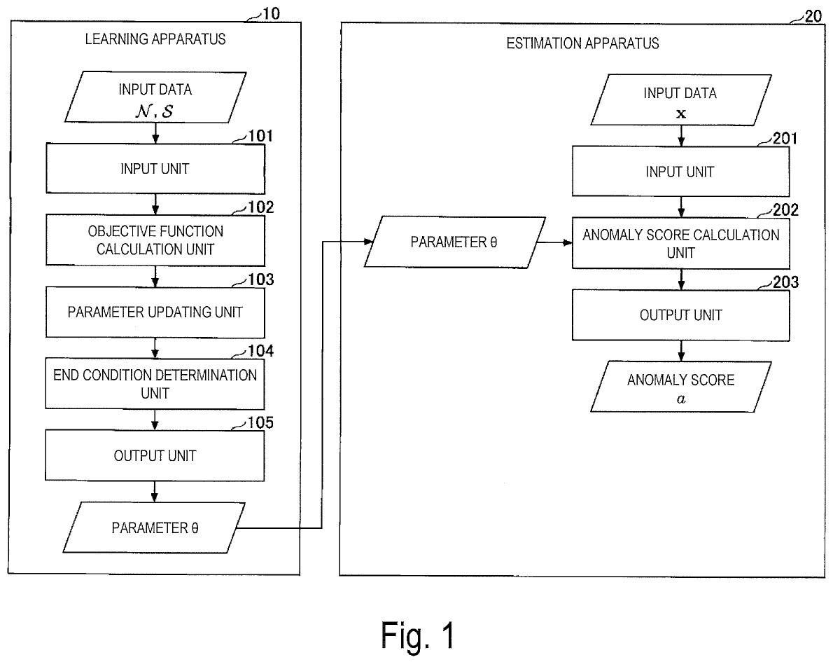

Next, an overall configuration of the learning apparatus 10 and the estimation apparatus 20 according to the embodiment of the present invention will be described with reference to FIG. 1. FIG. 1 is a diagram illustrating an example of the overall configuration of the learning apparatus 10 and the estimation apparatus 20 according to the embodiment of the present invention.

Learning Apparatus 10

As illustrated in FIG. 1, the learning apparatus 10 according to the embodiment of the present invention includes an input unit 101, an objective function calculation unit 102, a parameter updating unit 103, an end condition determination unit 104, and an output unit 105 as functional units.

The input unit 101 inputs, as input data, a given normal data set:

[symbol]

={xⱼ^{N}}ⱼ₌₁^{|} [symbol] ^{|} [Math. 2]

and a collection of given inaccurate anomalous data sets:

[symbol]

={ [symbol] ₖ}ₖ₌₁^{|} [symbol] ^{|} [Math. 3]

### Here,

xⱼ^{N}=(xⱼ₁^{N}, . . . ,x_{jD}^{N}) [Math. 4]

represents a D-dimensional feature vector of the j-th piece of normal data. Furthermore,

[symbol]

ₖ={xₖᵢ^{B}}ᵢ₌₁^{|} [symbol] ^{_{k|}} [Math. 5]

represents a k-th inaccurate anomalous data set, in which at least one piece of data is assumed to be anomalous. Furthermore,

xₖᵢ^{B} [Math. 6]

represents a D-dimensional feature vector of the i-th piece of data of the k-th inaccurate anomalous data set.

Note that the inaccurate anomalous data set means a set of data that can be anomalous but may not be truly anomalous. As described above, however, at least one piece of data in the inaccurate anomalous data set is assumed to be anomalous.

The objective function calculation unit 102 calculates a value of a predetermined objective function and a derivative value of the objective function regarding the parameter of the anomaly score estimation model. Here, as described above, in the embodiment of the present invention, in a case where data is provided, a value that becomes low when the data frequently appears and becomes high when the data infrequently appears is used as the anomaly score. In anomaly detection, in general, anomalous data is considered to have a lower frequency of appearance compared to normal data, and thus in the embodiment of the present invention, the parameter θ of the anomaly score estimation model is estimated (trained) so that the anomaly score becomes low for data included in the normal data set (i.e., normal data) and the anomaly score of at least one piece of data in the inaccurate anomalous data set becomes higher than the anomaly score of the normal data.

Due to this, in the embodiment of the present invention, for example, the objective function shown in Equation (2) below can be used:

$$\begin{matrix} [ Math . 7 ] & \\ E = \frac{1}{\vert 𝒩 \vert} {\sum }_{{x}_{j}^{N} ∈ 𝒩} a ( {x}_{j}^{N} ) - λ \frac{1}{\vert 𝒮 \vert \vert 𝒩 \vert} {\sum }_{{ℬ}_{k} ∈ 𝒮} {\sum }_{{x}_{j}^{N} ∈ 𝒩} σ ( {max}_{{x}_{ki}^{B} ∈ {ℬ}_{k}} a ( {x}_{k i}^{B} ) > a ( {x}_{j}^{N} ) ) & ( 2 )\end{matrix}$$

Here, λ≥0 represents a hyperparameter, and σ(·) represents a sigmoidal function:

$$[ Math . 8 ] \\ σ ( s ) = \frac{1}{1 + exp ( - s )} \qquad$$

Note that instead of the sigmoidal function, it is possible to use any function in which a large value is taken when the anomaly score of the anomalous data is higher than the anomaly score of the normal data and a large value is taken when the anomaly score of the anomalous data is lower than the anomaly score of the normal data.

When the objective function shown in Equation (2) above is minimized, the first term has an effect of reducing the anomaly score of the normal data, and the second term has an effect of making the anomaly score of at least one piece of data in the inaccurate anomalous data set higher than the anomaly score of the normal data. For the minimization of the objective function shown in Equation (2), for example, a stochastic gradient descent method or the like may be used. Furthermore, as the hyperparameter λ, for example, what has a preferred second term (that is, what has a higher value of the second term) may be used when a development data set is used. Note that, instead of the second term of the objective function of Equation (2) above, for example, Noisy-OR or the like may be used.

The parameter updating unit 103 uses the value of the objective function and the derivative value of the objective function regarding the parameter of the anomaly score estimation model calculated by the objective function calculation unit 102 to update the parameter θ such that the value of the objective function is reduced.

The calculation of the value of the objective function and the derivative value thereof and the updating of the parameter θ are repeated until a predetermined end condition is satisfied. As a result, the parameter θ of the anomaly score estimation model is trained.

The end condition determination unit 104 determines whether or not the predetermined end condition is satisfied. Examples of the predetermined end condition include that the number of repetitions reaches a predetermined number, that the change quantity of the value of the objective function becomes less than a predetermined value, that the change quantity of the parameter θ of the anomaly score estimation model becomes less than a predetermined value, and the like.

When the end condition determination unit 104 determines that the predetermined end condition is satisfied, the output unit 105 outputs the parameter θ of the anomaly score estimation model. The output unit 105 may output the parameter θ of the anomaly score estimation model to any output destination. For example, the output unit 105 may output the parameter θ to an auxiliary storage apparatus or the like of the learning apparatus 10, or may output (transmit) the parameter θ to the estimation apparatus 20 via a communication network or the like.

Estimation Apparatus 20

As illustrated in FIG. 1, the estimation apparatus 20 according to the embodiment of the present invention includes an input unit 201, an anomaly score calculation unit 202, and an output unit 203 as functional units.

The input unit 201 inputs, as input data, a given data x (that is, a data x to be subjected to anomaly detection). Here, the data x is a D-dimensional feature vector.

The anomaly score calculation unit 202 uses the parameter θ trained by the learning apparatus 10 to calculate an anomaly score a of the data x input by the input unit 201, for example, using the anomaly score estimation model shown in the above Equation (1). As a result, the anomaly score a of the data x to be subjected to anomaly detection is estimated.

The output unit 203 outputs the anomaly score a calculated by the anomaly score calculation unit 202. The output unit 203 may output the anomaly score a to any output destination. For example, the output unit 105 may output the anomaly score a to an auxiliary storage apparatus or the like of the estimation apparatus 20, or may output (transmit) the anomaly score a to other devices via a communication network or the like.

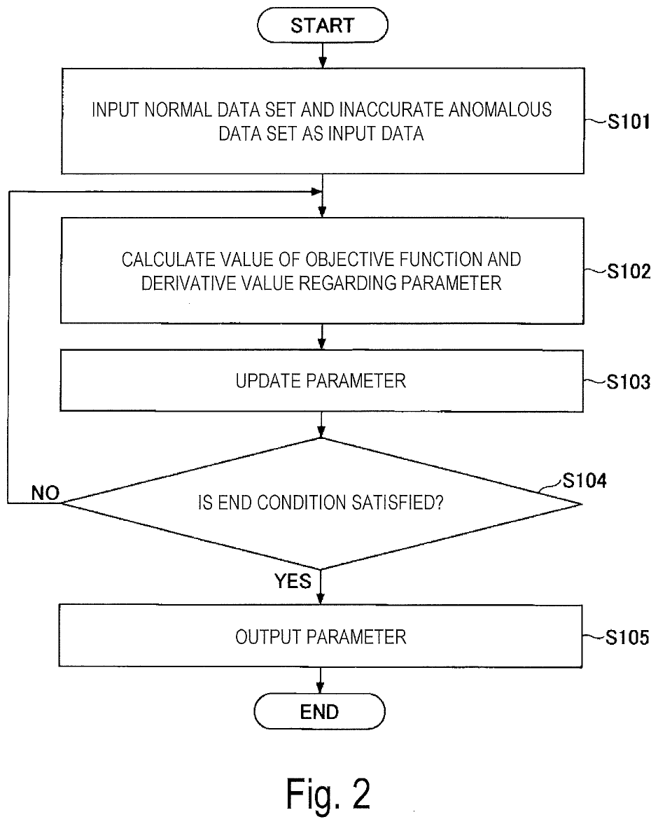

Parameter training processing Hereinafter, processing of training the parameter θ of the anomaly score estimation model in the learning apparatus 10 (parameter training processing) will be described with reference to FIG. 2. FIG. 2 is a flowchart illustrating an example of the parameter training processing according to the embodiment of the present invention.

First, the input unit 101 inputs, as input data, a normal data set:

[symbol]

={xⱼ^{N}}ⱼ₌₁^{|} [symbol] ^{|} [Math. 9]

and a collection of inaccurate anomalous data sets:

[symbol]

={ [symbol] ₖ}ₖ₌₁^{|} [symbol] ^{|} [Math. 10]

to the objective function calculation unit 102 (step S101). Here, for each k,

[symbol]

ₖ={xₖᵢ^{B}}ᵢ₌₁^{|} [symbol] ^{_{k|}} [Math. 11]

is satisfied. Note that, as described above, at least one piece of data is assumed to be anomalous in the k-th inaccurate anomalous data set for each k.

Next, the objective function calculation unit 102 uses normal data included in the normal data set and data included in unfair anomalous data sets to calculate the value of the objective function shown in the above Equation (2) and the derivative value of the objective function regarding the parameter of the anomaly score estimation model shown in the above Equation (1) (step S102).

Next, the parameter updating unit 103 uses the value of the objective function and the derivative value calculated in step S102 described above to update the parameter θ such that the value of the objective function is reduced (step S103).

Next, the end condition determination unit 104 determines whether or not the predetermined end condition is satisfied (step S104). In accordance with a determination that the predetermined end condition is not satisfied, the parameter training processing returns to step S102. In this way, step S102 to step S104 described above are repeatedly performed until it is determined that the predetermined end condition is satisfied.

On the other hand, in accordance with a determination that the predetermined end condition is satisfied, the output unit 105 outputs the parameter θ of the anomaly score estimation model (step S105). This results in the trained parameter θ.

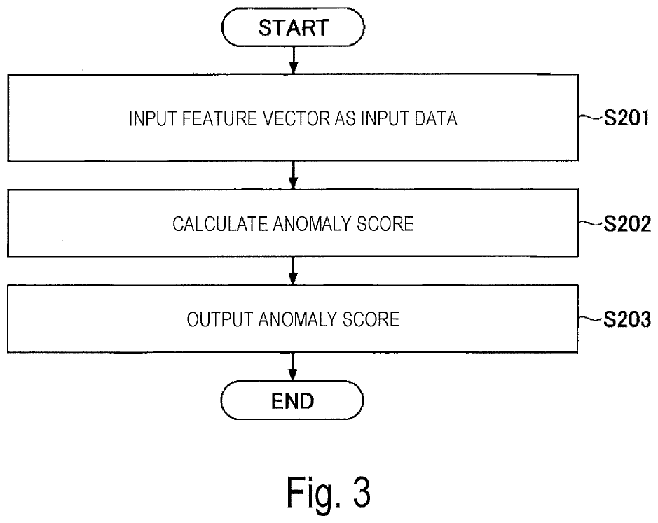

Anomaly score estimation processing Hereinafter, processing of estimating an anomaly score of data to be subjected to anomaly detection in the estimation apparatus 20 (anomaly score estimation processing) will be described with reference to FIG. 3. FIG. 3 is a flowchart illustrating an example of the anomaly score estimation processing according to the embodiment of the present invention.

First, the input unit 201 inputs, as input data, a data x to be subjected to anomaly detection (step S201). Here, the data x is a D-dimensional feature vector.

Next, the anomaly score calculation unit 202 uses the trained parameter θ to calculate the anomaly score a of the data x using the anomaly score estimation model shown in the above Equation (1) (step S202). In this way, the anomaly score a of the data x is estimated.

Finally, the output unit 203 outputs the anomaly score a calculated in step S202 described above (step S203). In this way, the anomaly score a of the data x to be subjected to anomaly detection is obtained. Note that the anomaly score a is used to determine whether the data x is normal or anomalous. For example, it is determined that the data x is normal when the anomaly score a is less than or equal to a predetermined threshold and that the data x is anomalous when the anomaly score a is greater than the predetermined threshold.

Performance evaluation Here, performance evaluation of the estimation apparatus 20 according to the embodiment of the present invention will be described. The Area Under the ROC Curve (AUC) is used as an evaluation index. The higher AUC indicates the higher anomaly detection performance (i.e., the estimation accuracy of the anomaly score is high).

Nine data sets (Annthyroid, Cardiotoco, IntemetAds, KDDCup99, PageBlocks, Pima, SpamBase, Waveform, Wilt) were used to evaluate the perfotmance of the estimation apparatus 20 according to the embodiment of the present invention. As comparison techniques, a local outlier factor (LOF), a one-class support vector machine (OSVM), an isolation forest (IF), an autoencoder (AE), a k-nearest neighbor (KNN), a support vector machine (SVM), a random forest (RF), a neural network (NN), a multiple instance learning (MIL), a supervised IF (SIF), and a supervised AE (SAE) were used.

At this time, the AUCs of the respective comparison techniques and the estimation apparatus 20 (Ours) according to the embodiment of the present invention are shown in Table 1 below.

TABLE 1

| | LOF | OSVM | IF | AE | KNN | SVM | RF | NN | MIL | SIF | SAE | Ours |
|---|---|---|---|---|---|---|---|---|---|---|---|---|
| Annthyroid | 0.614 | 0.489 | 0.641 | 0.745 | 0.527 | 0.631 | 0.738 | 0.603 | 0.540 | 0.856 | 0.829 | 0.773 |
| Cardiotoco | 0.547 | 0.832 | 0.806 | 0.731 | 0.611 | 0.585 | 0.828 | 0.568 | 0.688 | 0.838 | 0.801 | 0.838 |
| InternetAds | 0.674 | 0.800 | 0.514 | 0.809 | 0.552 | 0.698 | 0.569 | 0.692 | 0.774 | 0.631 | 0.834 | 0.807 |
| KDDCup99 | 0.571 | 0.993 | 0.990 | 0.996 | 0.794 | 0.678 | 0.892 | 0.980 | 0.689 | 0.993 | 0.971 | 0.994 |
| PageBlocks | 0.763 | 0.912 | 0.927 | 0.938 | 0.633 | 0.479 | 0.775 | 0.471 | 0.600 | 0.935 | 0.872 | 0.916 |
| Pima | 0.597 | 0.655 | 0.679 | 0.725 | 0.524 | 0.577 | 0.589 | 0.345 | 0.705 | 0.725 | 0.629 | 0.722 |
| SpamBase | 0.537 | 0.640 | 0.734 | 0.796 | 0.587 | 0.546 | 0.763 | 0.704 | 0.642 | 0.807 | 0.806 | 0.790 |
| Waveform | 0.700 | 0.612 | 0.688 | 0.665 | 0.542 | 0.485 | 0.617 | 0.676 | 0.483 | 0.737 | 0.620 | 0.681 |
| Wilt | 0.695 | 0.373 | 0.525 | 0.864 | 0.515 | 0.560 | 0.716 | 0.605 | 0.511 | 0.723 | 0.837 | 0.922 |
| Average | 0.633 | 0.701 | 0.723 | 0.808 | 0.587 | 0.582 | 0.721 | 0.627 | 0.626 | 0.805 | 0.800 | 0.827 |

Note that in Table 1 above, Average represents the average value of AUCs for the data sets.

As shown in Table 1 above, it can be seen that the estimation apparatus 20 (Ours) according to the embodiment of the present invention achieves high performance in more data sets than the other comparison techniques.

Hardware Configuration

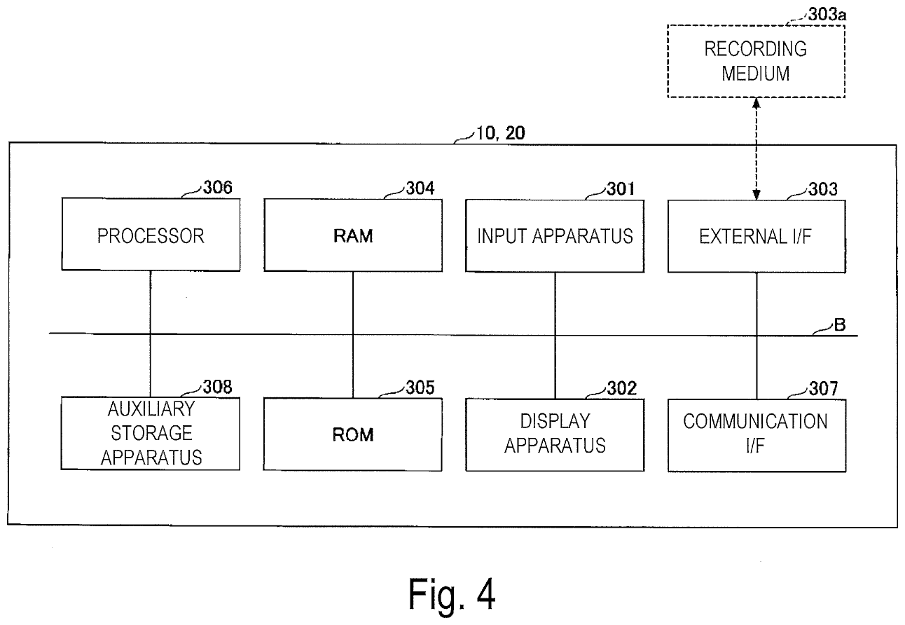

Finally, a hardware configuration of the learning apparatus 10 and the estimation apparatus 20 according to the embodiment of the present invention will be described with reference to FIG. 4. FIG. 4 is a diagram illustrating an example of a hardware configuration of the learning apparatus 10 and the estimation apparatus 20 according to the embodiment of the present invention. The learning apparatus 10 and the estimation apparatus 20 can be implemented in a similar hardware configuration, and thus the hardware configuration of the learning apparatus 10 will be mainly described hereinafter.

As illustrated in FIG. 4, the learning apparatus 10 according to the embodiment of the present invention includes an input apparatus 301, a display apparatus 302, an external I/F 303, a random access memory (RAM) 304, a read only memory (ROM) 305, a processor 306, a communication I/F 307, and an auxiliary storage apparatus 308. Each hardware is communicatively connected through a bus B.

The input apparatus 301 is, for example, a keyboard, a mouse, a touch panel, or the like, and is used by the user to input various operations. The display apparatus 302 is, for example, a display or the like, and displays a processing result of the learning apparatus 10, or the like. The learning apparatus 10 and the estimation apparatus 20 need not include at least one of the input apparatus 301 and the display apparatus 302.

The external I/F 303 is an interface with an external apparatus. The external apparatus includes a recording medium 303a, or the like. The learning apparatus 10 can read and write the recording medium 303a, or the like via the external I/F 303. In the recording medium 303a, for example, one or more programs for implementing each of the functional units included in the learning apparatus 10 (for example, the input unit 110, the objective function calculation unit 120, the parameter updating unit 130, the end condition determination unit 140, the output unit 150, and the like) may be recorded, or one or more programs for implementing each of the functional units included in the estimation apparatus 20 (for example, the input unit 210, the anomaly score calculation unit 220, the output unit 230, and the like) may be recorded.

The recording medium 303a includes, for example, a flexible disk, a Compact Disc (CD), a Digital Versatile Disk (DVD), a Secure Digital memory card (SD memory card), a Universal Serial Bus (USB) memory card, or the like.

The RAM 304 is a volatile semiconductor memory that temporarily retains a program and data. The ROM 305 is a non-volatile semiconductor memory that can retain a program and data even when the power is turned off. The ROM 305 stores, for example, setting information related to an operating system (OS), setting information related to a communication network, or the like.

The processor 306 is, for example, a Central Processing Unit (CPU), a Graphics Processing Unit (GPU), or the like, and is an operation apparatus that reads a program or data from the ROM 305, the auxiliary storage apparatus 308, or the like onto the RAM 304 to execute processing. The functional units included in the learning apparatus 10 are implemented when one or more programs stored in the ROM 305, the auxiliary storage apparatus 308, or the like are read out to the RAM 304 and the processor 306 executes the processing. Similarly, the functional units included in the estimation apparatus 20 are implemented when one or more programs stored in the ROM 305, the auxiliary storage apparatus 308, or the like are read out to the RAM 304 and the processor 306 executes the processing.

The communication I/F 307 is an interface to connect the learning apparatus 10 to a communication network. One or more programs that implement the functional units included in the learning apparatus 10 or one or more programs that implement the functional units included in the estimation apparatus 20 may be acquired (downloaded) from a predetermined server apparatus or the like via the communication I/F 307.

The auxiliary storage apparatus 308 is, for example, a Hard Disk Drive (HDD), a Solid State Drive (SSD), or the like, and is a non-volatile storage apparatus that stores a program and data. The program and data stored in the auxiliary storage apparatus 308 include, for example, an OS, an application program that implements various functions on the OS, or the like. One or more programs that implement the functional units included in the learning apparatus 10 are stored in the auxiliary storage apparatus 308 of the learning apparatus 10. Similarly, one or more programs that implement the functional units included in the estimation apparatus 20 are stored in the auxiliary storage apparatus 308 of the estimation apparatus 20.

The learning apparatus 10 according to the embodiment of the present invention has the hardware configuration illustrated in FIG. 4 and thus can implement the parameter training processing described above. Similarly, the estimation apparatus 20 according to the embodiment of the present invention has the hardware configuration illustrated in FIG. 4 and thus can implement the anomaly score estimation processing described above.

Note that in the example illustrated in FIG. 4, although a case where each of the learning apparatus 10 and the estimation apparatus 20 according to the embodiment of the present invention is implemented by one apparatus (computer) is illustrated, the present invention is not limited to the case. At least one of the learning apparatus 10 and the estimation apparatus 20 according to the embodiment of the present invention may be implemented by a plurality of apparatuses (computers). Additionally, a plurality of processors 306 and a plurality of memories (the RAM 304 and the ROM 305, auxiliary storage apparatus 308, or the like) may be included in one apparatus (computer).

The present invention is not limited to the specifically disclosed embodiment above, and various modifications and changes can be made without departing from the scope of the claims.

### REFERENCE SIGNS LIST

10 Learning apparatus
20 Estimation apparatus
101 Input unit
102 Objective function calculation unit
103 Parameter updating unit
104 End condition determination unit
105 Output unit
201 Input unit
202 Anomaly score calculation unit
203 Output unit

1. A learning apparatus, comprising:
a processor; and
a memory that includes instructions, which when executed, cause the processor to serve as:
an input unit configured to input a first data set constituted by data indicative of being normal and a second data set constituted by a collection of data sets including at least one piece of data indicative of being anomalous;
a calculation unit configured to calculate, using data included in the first data set and data included in the second data set, a value of an objective function utilizing a model and a derivative value of the objective function regarding a parameter of the model, the model estimating an anomaly score of data; and
an updating unit configured to update, using the value of the objective function and the derivative value, the parameter of the model.

2. The learning apparatus according to claim 1, wherein as to an anomaly score estimated by the model, a value of the anomaly score decreases for data having a high probability of appearance, and the value of the anomaly score increases for data having a low probability of appearance.

3. The learning apparatus according to claim 1, wherein
the objective function includes a first term for reducing an anomaly score of the data indicative of being normal and a second term for making an anomaly score of at least one piece of data in the data sets constituting the second data set higher than the anomaly score of the data indicative of being normal, and
the updating unit updates the parameter of the model to minimize the value of the objective function.

4. An estimation apparatus, comprising:
a processor; and
a memory that includes instructions, which when executed, cause the processor to serve as:
an input unit configured to input data to be subjected to estimation of an anomaly score; and
an estimation unit configured to estimate, using a parameter of a model, an anomaly score of the data to be subjected to estimation, the parameter of the model being trained in advance such that a value of the anomaly score is reduced for data with a high probability of appearance and the value of the anomaly score is increased for data with a low probability of appearance.

5. A learning method, comprising, by a computer:
inputting a first data set constituted by data indicative of being normal and a second data set constituted by a collection of data sets including at least one piece of data indicative of being anomalous;
calculating, using data included in the first data set and data included in the second data set, a value of an objective function utilizing a model and a derivative value of the objective function regarding a parameter of the model, the model estimating an anomaly score of data; and
updating, using the value of the objective function and the derivative value, the parameter of the model.

6-7. (canceled)
